(19) United States
(12) Patent Application Publication
(10) Pub. No.: US 2025/0083265 A1
(43) Pub. Date: Mar. 13, 2025

(54) Welding Hand Support Device

(71) Applicant: Michael Francis, Madison, AL (US)

(72) Inventor: Michael Francis, Madison, AL (US)

(21) Appl. No.: 18/244,431

(22) Filed: Sep. 11, 2023

(51) Int. Cl. B23K 37/02

(52) U.S. Cl. CPC B23K 37/0205

(57) ABSTRACT

A welding hand support device of the present disclosure has a body that has a first base and a second base. The body has a first opening on one side and on an opposing side has a second opening. Further, the welding hand support device has a channel formed in the body traversing the body from the first opening to the second opening, the channel configured to receive a welding device.

### BACKGROUND

Welding is a fabrication process that joins materials, usually metals or thermoplastics, by using high heat to melt the parts together and allowing them to cool, causing fusion. Welding is distinct from lower temperature techniques such as brazing and soldering, which do not melt the base metal.

To weld the materials together, a welder uses a handheld device comprising an electrode. The electrode is heated, and an inert gas is emitted out from the handheld device surrounding the electrode. Some handheld devices employ a consumable wire that acts as both the electrode and the filler material.

The process of welding is time-consuming. In this regard, the welder may use the handheld device for a considerable length of time. Holding the handheld device for a considerable period is often difficult on the welder's hand, wrist, and/or forearm. Extended use of the handheld device often causes occupational injuries in both the welder's hand, wrist and/or forearm.

### DESCRIPTION OF DRAWINGS

The present disclosure can be better understood by referencing the following drawings. The elements of the drawings are not necessarily to scale relative to each other, emphasis instead being placed upon clearly illustrating the principles of the present disclosure. Furthermore, like reference numerals designate corresponding parts throughout the several views.

FIG. 1 is a handheld welding device used in the welding process to join materials together.

FIG. 2 is the handheld welding device of FIG. 1 depicting a welding hand support device in accordance with an embodiment of the present disclosure.

FIG. 3 is a perspective view of the welding hand support device as shown in FIG. 2.

FIG. 4 is a left side view of the welding hand support device as shown in FIG. 2.

FIG. 5 is a right-side view of the welding hand support device shown in FIG. 2.

FIG. 6 is a cross-sectional view of the right side of the welding hand support device shown in FIG. 2.

FIG. 7 is a cross-section view of the left side of the welding hand support device shown in FIG. 2.

FIG. 8 is an end view of the welding hand support device shown in FIG. 2.

### DESCRIPTION

The present disclosure is a welding hand support device that supports an operator's hand while the operator is welding. In this regard, a welding device comprises a handle, and the welding hand support device comprises an opening through which the welding device is inserted.

In particular, the welding hand support device comprises a substantially cylindrical body. There is a first opening on one side of the substantially cylindrical body and a second opening on the other side of the substantially cylindrical body opposing the first opening. Further, the first opening and the second opening enable access to an angular channel that extends from the first opening to the second opening. The welding device is inserted through the angular channel such that a top portion of the welding device protrudes out the first opening and the bottom portion of the welding device protrudes out the second opening.

The operator grasps the welding device and the welding hand support. When grasping the welding device, the operator's palm rests on the welding hand support device. The operator's middle finger, ring finger, and little finger wrap around the welding hand support device. The operator's index finger wraps around the welding device and grasps the welding device toward a tip of the welding device. The operator's thumb extends upwardly and grasps the side of the welding hand support device that the middle finger, ring finger, and little finger grasp. The fingers grasping the welding device and the welding hand support device enable the operator to rest the palm of the operator's hand and provide support during use, i.e., while the operator is welding, thereby creating a more ergonomic grasp for the welder.

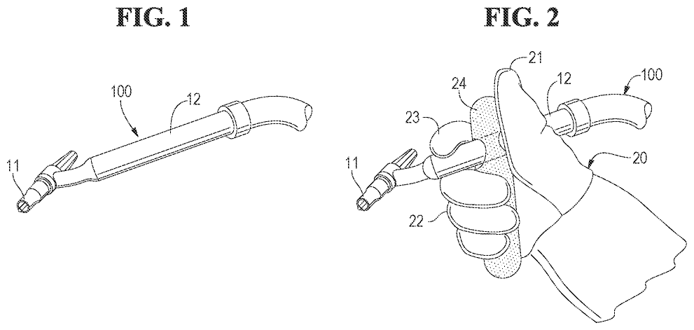

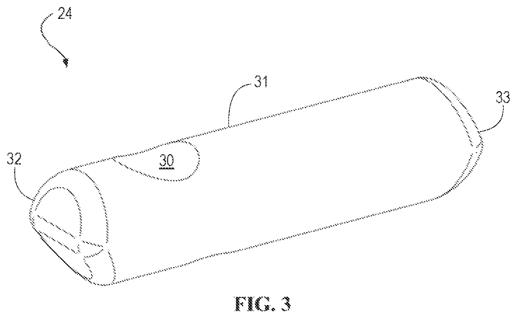

FIG. 1 is a drawing of a welding device 100. The welding device 100 comprises a tip 11. Through the tip 11 extends an electrode 13. Around the electrode 13 is an open channel 14 that emits inert gas.

The welding device 100 further comprises a handle 12. The operator grasps the handle 12 when in use. The operator moves the tip 11 of the welding device 100 along an area between a base metal and a weld metal that are being fused together. The electrode 13 heats the base metal and the weld metal, melting the base metal and the weld metal, so that the materials may be fused together. Inert gas is emitted from the channel 14 to protect arcing that occurs during the welding of the base metal to the weld metal.

FIG. 2 is a drawing of the welding device 100 grasped by an operator's hand 20. The welding device 100 is inserted through the welding hand support device 24. The operator firmly grasps the welding hand support device 24 and the welding device 100. The operator's middle finger, ring finger, and little finger 22 wrap around the welding hand support 24, while the operator's index finger 23 wraps around the welding device 100. The operator presses his/her thumb 21 against the welding device 100 and the welding hand support 24 to firmly grasp the welding device 100. While the operator is welding a base metal to a weld metal, the operator rests his/her palm on the welding hand support device 24. This enables the operator to rest his/her hand 20 during the welding process.

FIG. 2 is a perspective view of the welding hand support device 24. The welding hand support device 24 comprises a cylindrical body 31. While a cylindrical body 31 is shown, the welding hand support device 24 may be other shapes in other embodiments, e.g., a cuboid or rectangular prism.

The cylindrical body 31 terminates on one end with base 32. On the opposing end, the cylindrical body 31 terminates with base 33. While FIG. 2 depicts the bases 32 and 33 have a rounded shape. The bases 32 and 33 may be other shapes in other embodiments. For example, the bases 32 and 33 may be flat.

The welding hand support device 24 further comprises an opening 30 its lateral face. The opening 30 opens to an angular channel (not shown).

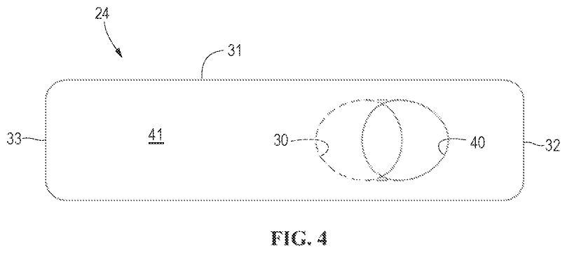

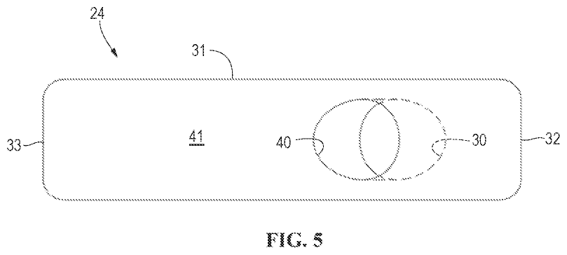

FIG. 4 is a right-side view of the welding hand support device 24. The cylindrical body 31 comprises a lateral face 41. The cylindrical body 31 comprises the lateral face 41.

As noted above, the lateral face 41 may be the lateral face of a cylindrical body. However, other shapes may be used in other embodiments.

In the lateral face is an opening 40. The opening 40 is formed in the lateral face 41 opposing the opening 30. Note that in one embodiment, opening 40 is offset from the opening 40 to form an angular channel (not shown) through the body 31.

The opening 30 and the opening 40 open to the angular channel. Thus, a welding device 100 may be inserted through the opening 30, through the angular channel, and exit the welding hand support device 24 via the opening 40.

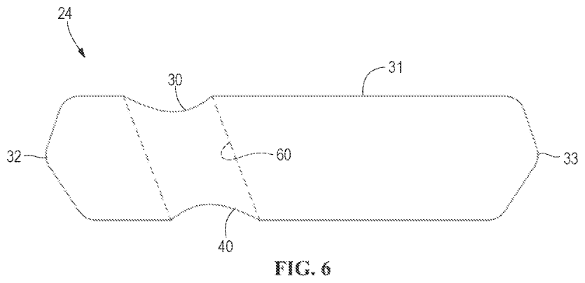

FIG. 5 is a left side view of the welding hand support device 24. The cylindrical body 31 comprises the lateral face 41.

As noted above, the lateral face 25 may be the lateral face of a cylindrical body. However, other shapes may be used in other embodiments. For example, the body 31 may be a cuboidal shape, and the openings 30 and 40 are formed in opposing sides and offset one from the other to form the angular channel.

In the lateral face 41 is the opening 40. The opening 40 is formed in the lateral face 41 opposing the opening 30. Note that in one embodiment, opening 30 if formed offset from the opening 40 to form an angular channel (not shown) through the body 31.

The opening 30 and the opening 40 open to the angular channel. Thus, a welding device 100 may be inserted through the opening 30, through the angular channel, and exit the welding hand support device 24 via the opening 40.

FIG. 6 is a cross-sectional view of the left section of the welding hand support 24. The welding hand support 24 comprises the body 31, which is shown in FIG. 6 as cylindrical.

The welding hand support 24 comprises the opening 30 on one side of the welding hand support device 24 and the opening 40 on an opposing side of the welding hand support device 24. The openings 30 and 40 open to a channel 60.

The opening 30 receives the welding device 100 (FIG. 1). The welding device 100 goes through the channel 60 and extends outwardly projecting from opening 40, as shown in FIG. 2.

The operator grasps the welding device 100 (FIG. 2) and the welding hand support 24. The operator welds and rests his/her hand on the welding hand support device 24.

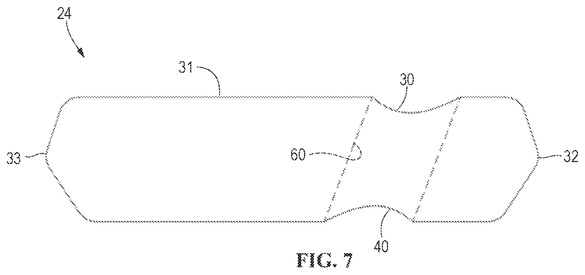

FIG. 7 is a cross-sectional view of the ride section of the welding hand support 24. The welding hand support 24 comprises the body 31, which is shown in FIG. 6 as cylindrical.

The welding hand support 24 comprises the opening 30 on one side of the welding hand support device 24 and the opening 40 on an opposing side of the welding hand support device 24. The openings 30 and 40 open to a channel 60.

The opening 30 receives the welding device 100 (FIG. 1). The welding device 100 goes through the channel 60 and extends outwardly projecting from opening 40, as shown in FIG. 2.

The operator grasps the welding device 100 (FIG. 2) and the welding hand support 24. The operator welds and rests his/her hand on the welding hand support device 24.

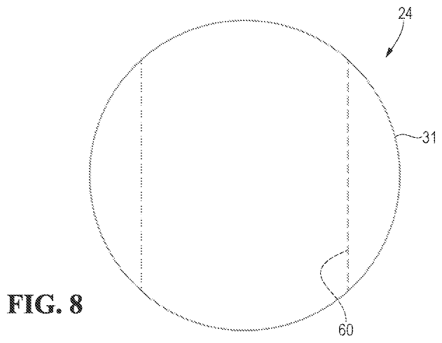

FIG. 8 is an end view of the welding support device 24. The welding support device 24 comprises the body 31. The body 31 is cylindrical in the embodiment shown in FIG. 8. However, the body 31 may be other shapes in other embodiments. For example, the body might be shaped as a rectangular prism.

Through the body 31 is the channel 60. The welding device 100 is inserted through the channel 60 so that the tip 11 (FIG. 1) of the welding device 100 protrudes outward from the lateral surface 41 of the body 31.

What I claim is:

1. A welding hand support device, comprising:
a body having a first base and a second base;
a first opening on one side of the body;
a second opening on an opposing side of the body, opposing the first opening;
a channel formed in the body traversing the body from the first opening to the second opening, the channel configured to receive a welding device.

2. The welding hand support device of claim 1, wherein the first and/or second base are rounded.

3. The welding hand support device of claim 1, wherein the first and/or the second base of are flat.

4. The welding hand support device of claim 1, wherein the first opening and the second opening are offset on from the other so that the channel is angular.

5. The welding hand support device of claim 1, wherein the body is cylindrical.
